(19) United States
(12) Patent Application Publication
(10) Pub. No.: US 2026/0222959 A1
(43) Pub. Date: Jul. 30, 2026

(54) CHO ENHANCEMENT BASED ON SOURCE AND TARGET CELLS IN NES MODE

(71) Applicant: APPLE INC., Cupertino, CA (US)

(72) Inventors: Peng Cheng, Beijing (CN); Fangli Xu, Beijing (CN); Haijing Hu, Los Gatos, CA (US); Yuqin Chen, Beijing (CN)

(21) Appl. No.: 19/145,065

(22) PCT Filed: Feb. 8, 2023
(86) PCT No.: PCT/CN2023/075068

§ 371 Date: Jul. 1, 2025

(51) Int. Cl. H04W 36/36; H04B 17/318; H04W 36/00; H04W 52/02; H04W 76/28

(52) U.S. Cl. CPC H04W 36/362; H04B 17/328; H04W 36/0058; H04W 52/0203; H04W 76/28

(57) ABSTRACT

Methods and apparatus are provided for conditional handover (CHO) based on source and target cells in a network energy saving (NES) mode. A base station is configured as a source cell for conditional handover (CHO) in a wireless network including cells in a network energy saving (NES) mode. The base station receives, from a user equipment (UE), measurement values corresponding to reference signals received at the UE from neighboring cells in the wireless network. The base station determines candidate target cells of the neighboring cells based on the measurement values and sends a CHO configuration to configure the candidate target cells at the UE. The CHO configuration includes a CHO condition. The base station sends an NES CHO configuration to apply when the source cell is in the NES mode and initiates a CHO procedure between the UE and a target cell of the candidate target cells.

### TECHNICAL FIELD

This application relates generally to wireless communication systems, including systems with conditional handover (CHO) between cells.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1(FR1 ) may include frequency bands operating in sub-6 GHz frequencies, some of which are bands that may be used by previous standards, and may potentially be extended to cover new spectrum offerings from 410 MHz to 7125 MHz. Frequency Range 2(FR2 ) may include frequency bands from 24.25 GHz to 52.6 GHZ. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A and FIG. 1B together illustrate a flow diagram for conditional handover that may be used in some wireless communications systems.

FIG. 2 is a flow diagram of an example NES CHO procedure according to certain embodiments.

FIG. 3 illustrates a flowchart of a method of a UE for CHO in a wireless network including cells in an NES mode according to one embodiment.

FIG. 4 illustrates a flowchart of a method of a base station configured as a source cell for CHO in a wireless network including cells in an NES mode according to one embodiment.

FIG. 5 illustrates an example architecture of a wireless communication system, according to embodiments disclosed herein.

FIG. 6 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In certain wireless systems, it would be useful to implement CHO enhancements when a source or target cell is in a network energy saving (NES) mode. Possible techniques on the gNB side and the UE side may be utilized to improve network energy savings in terms of both base station transmission and reception. For example, efforts to achieve more efficient operation dynamically and/or semi-statically and for finer granularity adaptation of transmissions and/or receptions may use one or more of network energy saving techniques in time, frequency, spatial domain, and power domain, with potential support/feedback from the UE and potential UE assistance information and/or information exchange/coordination over network interfaces.

NES techniques may include, for example, synchronization signal block (SSB)-less secondary cell (SCell) operation for inter-band carrier aggregation (CA) for FR1 and co-located cells, using cell discontinuous transmission (DTX) and/or discontinuous reception (DRX), using adaptation of spatial elements (e.g. antenna ports, active transceiver chains, etc.), using physical downlink shared channel (PDSCH) transmit power adaptation, using paging enhancements, and preventing legacy UEs from camping on cells adopting new NES techniques, if necessary. Other techniques are not precluded and may prioritize, for example, idle/empty and low/medium load scenarios. Further, different loads among carriers and neighbor cells may be allowed.

### Conditional Handover

Conditional handover (CHO) is a feature introduced to improve mobility robustness. In CHO, the UE may be configured with a handover command and an associated condition to be monitored. The UE may execute the stored “handover” command when the associated condition(s) become true. Event conditions may include, for example, when a neighbor cell becomes better than a special cell (SpCell) by an offset (i.e., an A3 event condition) or when the SpCell becomes worse than a first threshold and the neighbor cell becomes better than a second threshold (i.e., an A5 event condition). The SpCell is the primary serving cell of either the Master Cell Group (MCG) or Secondary Cell Group (SCG), and the offset may be either positive or negative. When more than one candidate target cell satisfies the condition, it may be up to the UE implementation to determine which cell may execute handover (HO). In certain wireless communication systems (e.g., 3GPP Release 17), new conditional trigger conditions related to location and time may be defined to help enhance CHO for NR non-terrestrial networks (NTN).

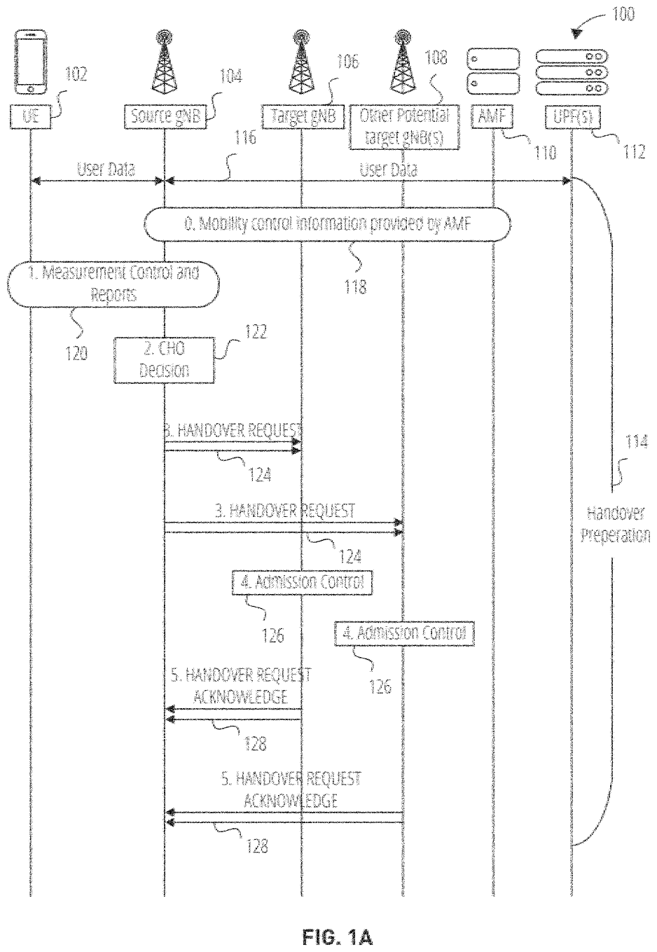

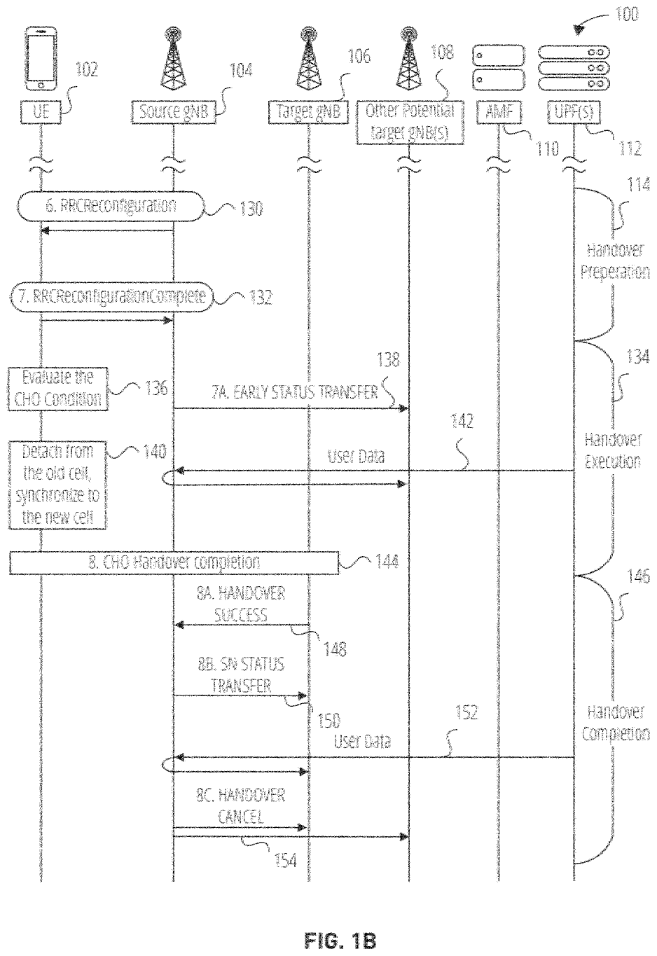

FIG. 1A and FIG. 1B together illustrate a flow diagram 100 for conditional handover that may be used in some wireless communications systems. The flow diagram 100 illustrates a wireless communication system that includes a UE 102, a source gNB 104, a target gNB 106, other potential target gNB(s) 108, an access and mobility management function (AMF) 110, and one or more user plane functions (UFP(s)) 112. As can be seen, the flow diagram 100 corresponds to an intra-AMF/UPF case.

As illustrated in FIG. 1A, the flow diagram 100 begins with the handover preparation phase 114. Presently, user data 116 is transported between the UE 102 and the source gNB 104 and between the source gNB 104 and the UFP(s) 112, as illustrated. The AMF 110 provides the source gNB 104 with mobility control information 118. Then, the source gNB 104 configures measurements at the UE 102, and the UE 102 performs measurements and reports measurement results to the source gNB 104, during the measurement control and reports 120. Based on the receipt of the measurement reporting, the source gNB 104 makes a CHO decision 122. Based on the CHO decision 122, the source gNB 104 sends handover requests 124 to other gNBs (in the flow diagram 100, both the target gNB 106 that will ultimately be selected as the target of the handover and other potential target gNB(s) 108 are illustrated as receiving the handover requests 124).

The other gNBs (e.g., the target gNB 106 and the other potential target gNB(s) 108) each perform admission control 126, and reply to the source gNB 104 with a handover request acknowledgement 128, including configuration of any CHO candidate cell(s) at that gNB.

FIG. 1B continues the flow diagram 100 discussed above in relation to FIG. 1A. The source gNB 104 sends the UE 102 a radio resource control (RRC) reconfiguration message 130 having the configuration for the CHO candidate cells. The UE 102 sends the source gNB 104 an RRC reconfiguration complete message 132.

The flow diagram 100 then enters the handover execution phase 134. The UE 102 evaluates 136 the CHO condition. Further, in some embodiments (e.g., where early data forwarding is used), the target gNB 106 sends the other potential target gNB(s) 108 an early status transfer message 138.

Then, the UE 102 detaches 140 from the old cell and synchronizes to a new cell (e.g., on the target gNB 106). As part of this process, the UE performs an evaluation of conditions on the candidate cell(s) and determines that the new cell (on the target gNB 106) meets the conditions and that it will accordingly handover to that cell. The configuration for that new cell is then applied at the UE.

Further, user data 142 is transported between the UFP(s) 112 and the target gNB 106 and/or the other potential target gNB(s) 108 via the source gNB 104. The CHO handover completion 144 occurs once the UE 102 becomes associated with the new cell on the source gNB 104 (and the UE 102 may send an attendant RRC reconfiguration complete message to the target gNB 106).

The flow diagram 100 then enters the handover completion phase 146. First, the target gNB 106 sends the source gNB 104 a handover success message 148. Then, the source gNB 104 sends the target gNB 106 a sequence number (SN) status transfer 150. User data 152 is transported between the UFP(s) 112 and the target gNB 106 via the source gNB 104. Finally, the source gNB 104 may send the target gNB 106 and/or the other potential target gNB(s) 108 a handover cancel message 154.

During the switching of NES modes, it may be possible to handover the UEs faster by enhancing the CHO framework through evaluation of CHO conditions depending on the NES mode of the source cell or target cell. However, systems have not yet defined how to indicate to the UE the triggering of the evaluation of such CHO conditions depending on the NES mode. When mobility from the source cell is triggered, the NES mode of the target cell may also be considered, for example, to avoid UEs selecting cells operating in NES mode if any other cell is available.

In certain wireless systems, an NES CHO enhancement solution may be based on only the target cell NES mode. For example, in a CHO configuration message (e.g., CHO-Config), a base station (e.g., gNB) may include different priority values for each candidate target cell. The priority value may be dedicated to each candidate target cell, or may be common to a group of candidate target cells. The base station may determine how to set the priority value. The base station's intentions or reasons for selecting the priority value may be transparent to the UE. Further, different priority values may be configured to different cell types. For example, the priority value may be based on whether the cell is an NES cell, an NTN cell, a TN cell, a mobile cell, a small cell, etc. For HO execution (e.g., see the handover execution phase 134 of the CHO procedure shown in FIG. 1B), if more than one candidate target cells satisfy the CHO condition, the UE may select the cell with the highest configured or default priority value to execute HO.

In addition, or in other wireless systems, an NES CHO enhancement solution includes triggering a group HO by UE group common Layer 1 and/or Layer 2 (L1/L2) signaling sent by the source cell. For example, only one target cell may be preconfigured and reception of the UE group common L1/L2 signaling may be the condition to execute the HO. When the source cell enters NES mode, the source cell may send the UE group common signaling to trigger the HO execution.

Certain embodiments disclosed herein provide a CHO enhancement solution based on an NES mode of both the source cell and the target cell. For example, after reception of the CHO command, the UE may start an evaluation of an existing or legacy CHO condition (e.g., A3 or A5 event conditions) and may switch to an NES specific CHO condition upon detection of the source cell in an NES mode. Instead of (or in addition to) explicit UE group common L1/L2 signaling, other implicit indication(s) of source cell NES mode change may be used. As discussed herein, the NES mode of the target cell may also be considered in the NES specific CHO condition evaluation.

In certain embodiments, after detecting that the source cell is in the NES mode, the UE uses different alternatives of the threshold offset for CHO condition evaluation. The threshold offset may be applied upon detection of the source cell entering an NES mode. The threshold offset may be configured to loosen the condition to execute the HO and to speed up the CHO completion. For the CHO condition evaluation for target cells in the NES mode, a different threshold offset may be applied to avoid UEs selecting cells operating in the NES mode if any other cell is available.

In another embodiment, after detecting that the source cell is in the NES mode, the UE switches to another configured CHO condition (e.g. an A4 event condition). The A4 event condition is based on a determination that a neighbor or target cell's reference signal received power (RSRP) or a reference signal received quality (RSRQ) is better than a threshold. Thus, the UE may only consider the neighbor cell's radio condition, irrespective of the source cell radio condition.

In certain embodiments, if both the normal cell (i.e., a cell not in an NES mode) and the NES cell (i.e., a cell that is in an NES mode) satisfy the NES specific CHO condition, the UE may prioritize the normal cell for HO execution.

### Example NES CHO Configuration

In certain embodiments, the base station (e.g., gNB) includes NES configuration parameters for each candidate target cell in either a CHO configuration message (e.g., CHO-Config) or an NES configuration message (e.g., NES-CHO-Config) to the UE. For each candidate target cell, the NES configuration parameters include an indication of whether the candidate target cell is in NES mode, optional priority values (e.g., value 0-7), and/or optional different CHO evaluation thresholds depending on whether the target cell is in the NES mode (i.e., different thresholds for normal cell operation and cell operation in the NES mode).

The configured priority value may be dedicated to each candidate target cell, or may be common to a group of candidate target cells. It may be up to the gNB as to how to set the priority value. The base station's intentions or reasons for selecting the priority value may be transparent to the UE. In certain embodiments, different priority values are configured to the target cell based on which NES technique(s) are used. For example, the gNB may configure a priority value of five (5) for a target cell applying cell DTX/DRX and a priority value of six (6) for a target cell applying adaptive PDSCH transmit power.

In certain embodiments, the NES configuration parameters include CHO condition evaluation threshold offset(s). A threshold offset may be an RSRP/RSRQ offset configured in a legacy CHO condition (e.g., an A3 or A5 event). The threshold offset may be one common offset or an NES cell specific offset. For example, in one embodiment, a common threshold offset is provided for all candidate target cells. In another embodiment, one threshold offset is provided for the candidate target cells that are indicated as a normal cell, and another threshold offset is provided for the candidate target cells that are indicated as a cell in NES mode.

In certain embodiments, the NES configuration parameters include one or more NES CHO condition, which is not used until detection of the source cell's NES mode change. For example, the A4 event condition may be indicated, wherein the target cell's RSRP/RSRQ is determined to be better than a threshold value. Thus, the UE may only consider the neighbor cell's radio condition, irrespective of the source cell's radio condition after the source cell enters NES mode.

In certain embodiments, the NES configuration parameters indicate that a new S-measure may be used upon detection of the source cell′ NES mode change. Thus, the UE can start the neighbor cell measurement earlier when the current serving cell enters NES mode.

### Example NES CHO Procedure

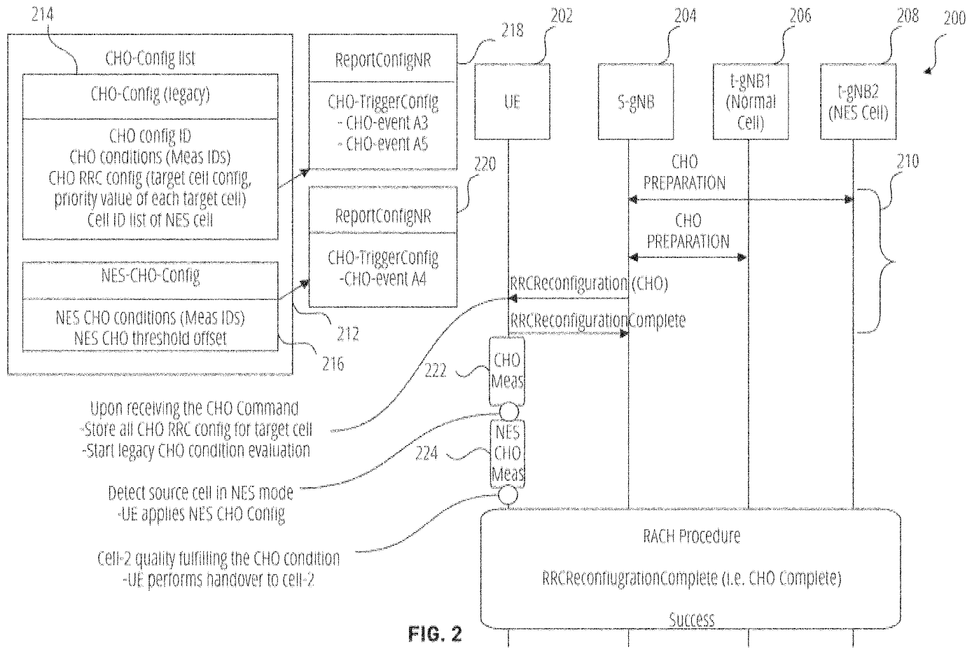

FIG. 2 is a flow diagram of an example NES CHO procedure 200 according to certain embodiments. In the illustrated example, a wireless communication system includes a UE 202, a source cell 204 (shown as S-gNB), a first target cell 206 (shown as t-gNB1), and a second target cell 208 (shown as t-gNB2). However, skilled persons will recognize from the disclosure herein that the wireless network may include fewer or more elements, including one or more additional candidate target cells.

A CHO preparation stage 210 shown in FIG. 2 may correspond to the handover preparation phase 114 shown in FIG. 1A and FIG. 1B. However, in the example shown in FIG. 2, a CHO configuration list 212 (shown as CHO-Config list) includes both a CHO configuration 214 (shown as CHO-Config (legacy)) and an NES CHO configuration 216 (shown as NES-CHO-Config). The CHO configuration 214 may include a CHO configuration identifier (CHO config ID), one or more CHO conditions with corresponding measurement identifiers (Meas IDs), a CHO RRC configuration (e.g., including, for each candidate target cell, a target cell configuration and a priority value), and a cell identifier (ID) list of NES cells. The NES CHO configuration 216 may include one or more NES CHO conditions and corresponding Meas IDs, and one or more NES CHO threshold offset. The source cell 204 may configure the UE 202 with both the CHO configuration 214 and the NES CHO configuration 216.

In addition, or in another embodiment, the source cell 204 may generate one or more report configuration message 218 (e.g., ReportConfigNR information element (IE)) from the CHO configuration 214 to specify criteria for triggering an NR measurement reporting event (e.g., CHO-TriggerConfig specifying legacy CHO-event A3 and/or CHO-event A5). The source cell 204 may also generate one or more report configuration message 220 (e.g., ReportConfigNR IE) from the NES CHO configuration 216 to specify criteria for triggering an NR measurement reporting event (e.g., CHO-TriggerConfig specifying NES CHO-event A4).

The source cell 204 may use an RRC reconfiguration message (RRCReconfiguration) to send a CHO command and/or the CHO configuration 214 and the NES CHO configuration 216 to the UE 202. In response, the UE 202 sends the source cell 204 an RRC reconfiguration complete message (RRCReconfigurationComplete).

Upon reception of the CHO command (and/or the CHO configuration list 212 and the NES CHO configuration 216) from the source cell 204, the UE stores the CHO RRC configurations for the target cells and starts the legacy CHO condition evaluation (i.e., performing CHO measurements 222 to evaluate the A3 or A5 condition without applying threshold offset(s)), until detection of the source cell's NES mode change. The UE 202 may use different CHO evaluation thresholds for different target cells, if configured.

If one or more candidate target cells satisfy the legacy CHO condition, the UE 202 starts execution of HO (e.g., using a legacy CHO procedure, as shown in FIG. 1A and FIG. 1B) with one or more enhancement based on at least one target cell in NES mode. For example, if two or more candidate target cells satisfy the CHO condition, the UE may select the candidate target cell based on prioritizing normal cells that are not in the NES mode (e.g., the first target cell 206) over cells that are in the NES mode (e.g., the second target cell 208). If more than one normal cell satisfy the CHO condition, it may be up to UE implementation to determine which one to select for HO execution. Note that the UE 202 may follow a configured cell list in CHO-Config to determine the NES cell(s). Thus, there may be no need to detect which of the candidate target cells are in the NES mode.

In another embodiment, if the priority values of the candidate target cells that satisfy the CHO condition are configured, the UE 202 may select the candidate target cell with the highest configured priority value to execute HO. If more than one candidate target cell satisfying the CHO condition has the same priority value, it may be up to UE implementation to determine which one to select for HO execution.

Otherwise, if no candidate target cell satisfies the legacy CHO condition, but the UE 202 detects that the source cell 204 enters NES mode, the UE 202 may switch to the CHO specific condition (i.e., performing NES CHO measurements 224 and applying the threshold offset(s) for corresponding candidate target cells or applying another CHO condition).

In one embodiment, the UE 202 detects that the source cell 204 enters the NES mode by the source cell 204 starting to bar legacy UEs via monitoring the master information block (MIB) and/or the system information block (SIB) of the source cell 204. For example, if either the cellBarred bit in the MIB is set to true and a new bit (e.g., allowNESUE) in the first SIB (SIB1) is set to true, or either a cell reservation bit in SIB1 (i.e., cellReservationForOtherUse or cellReservationForFutureUse) is set to true and a new bit (e.g., allowNESUE) in SIB1 is set to true, then the UE determines that the source cell 204 has switched to the NES mode.

In addition, or in other embodiments, the source cell 204 may detect that the source cell 204 enters the NES mode upon one or more of reception of RRC signaling or L1/L2 signaling to apply cell DTX/DRX from the source cell 204, reception of RRC signaling or L1/L2 signaling to apply spatial elements adaptation from the source cell 204, reception of RRC signaling or L1/L2 signaling to apply PDSCH transmit power adaptation from the source cell 204, and/or reception of a UE group common or a UE dedicated L1/L2 signaling indicating that the source cell 204 has switched to the NES mode. In certain embodiments, the UE 202 is configured to respond to the group common or UE dedicated L1/L2 signaling indicating that the source cell 204 has switched to the NES mode with L2 signaling for confirmation (e.g., using a media access control (MAC) control element (CE)).

After configuration of the NES CHO condition may be applied (i.e., after the UE 202 releases the legacy CHO configuration 214 and applies the NES CHO configuration 216), the UE 202 may start NES CHO measurements 224 for NES CHO condition evaluation to speed up execution of HO. In the example shown in FIG. 2, the UE 202 selects the second target cell 208 (i.e., cell-2 quality fulfils the CHO condition or NES CHO condition and the UE 202 performs handover to cell-2). For example, the UE 202 may perform a random access channel (RACH) procedure with the selected candidate target cell. The CHO handover completion occurs once the UE 202 becomes associated with the new cell on the source cell 204 (and the UE 202 may send an attendant RRC reconfiguration complete message (RRCReconfigurationComplete) to the selected target cell. In a handover completion phase, the selected target cell sends the source cell 204 a handover success message.

In certain embodiments, if two or more candidate target cells satisfy the NES CHO condition, the UE may select the candidate target cell based on prioritizing normal cells that are not in the NES mode (e.g., the first target cell 206) over cells that are in the NES mode (e.g., the second target cell 208). If more than one normal cell satisfy the NES CHO condition, it may be up to UE implementation to determine which one to select for HO execution. In another embodiment, if the priority values of the candidate target cells that satisfy the NES CHO condition are configured, the UE 202 may select the candidate target cell with the highest configured priority value to execute HO. If more than one candidate target cell satisfying the NES CHO condition has the same priority value, it may be up to UE implementation to determine which one to select for HO execution.

### Failure Handling

In one embodiment, if the HO execution is failed (e.g., caused by RACH failure), the UE may perform cell selection wherein if both the normal cell(s) and the NES cell(s) configured in CHO are suitable, the normal cell(s) may be prioritized during cell selection to execute handover.

In another embodiment, if the HO execution is failed (e.g., caused by RACH failure), the UE may perform cell selection wherein if there are cells configured being suitable, the UE follows the configured priority values to select the cell to execute handover.

### Inter-Node Signaling

In certain embodiments, inter-node signaling is used to exchange the NES mode and the preferred priority value between base stations. For example, the inter-node signaling may indicate to apply cell DTX/DRX from the source cell, spatial elements adaptation from the source cell, PDSCH transmit power adaptation from the source cell, and/or paging enhancement.

As another example, a candidate target cell may use inter-node signaling to forward its preferred priority value to the source cell. In certain such embodiments, however, it may be up to the source cell to determine the priority value to include in the CHO configuration and/or the NES CHO configuration.

### Example Embodiments

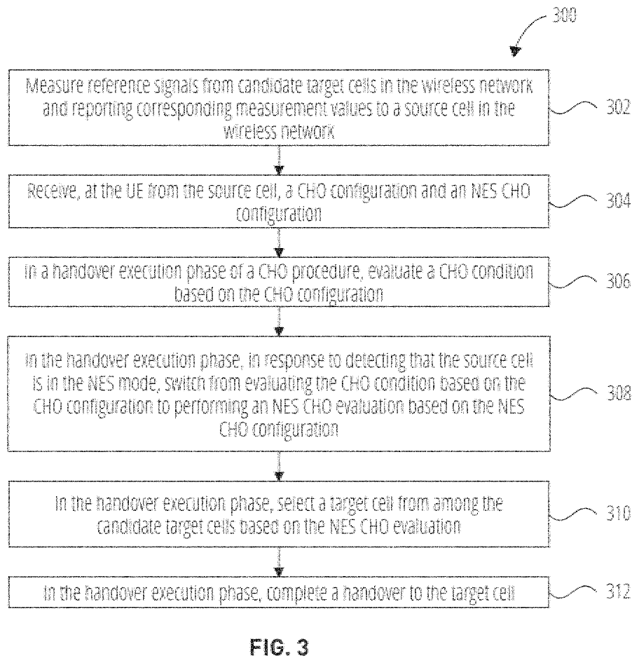

FIG. 3 illustrates a flowchart of a method 300 of a UE for CHO in a wireless network including cells in an NES mode, according to one embodiment. The method 300 includes measuring 302 reference signals from candidate target cells in the wireless network and reporting corresponding measurement values to a source cell in the wireless network. The method 300 further includes receiving 304, at the UE from the source cell, a CHO configuration and an NES CHO configuration. The method 300 further includes a handover execution phase of a CHO procedure that includes evaluating 306 a CHO condition based on the CHO configuration. The handover execution phase further includes, in response to detecting that the source cell is in the NES mode, switching 308 from evaluating the CHO condition based on the CHO configuration to performing an NES CHO evaluation based on the NES CHO configuration. The handover execution phase further includes selecting 310 a target cell from among the candidate target cells based on the NES CHO evaluation, and completing 312 a handover to the target cell.

In some embodiments of the method 300, selecting the target cell comprises prioritizing a first subset of the candidate target cells in a non-NES mode over a second subset of the candidate target cells in the NES mode.

In some embodiments of the method 300, the NES CHO configuration comprises a first NES CHO threshold offset. Evaluating the CHO condition comprises comparing measurements of the reference signals from the candidate target cells to a threshold to detect a CHO event. Performing the NES CHO evaluation comprises comparing the measurements of the reference signals from one or more of the candidate target cells to the first NES CHO threshold offset to detect the CHO event.

In certain such embodiments of the method 300, the NES CHO configuration further comprises a second NES CHO threshold offset, and performing the NES CHO evaluation further comprises: comparing the measurements of the reference signals from a first subset of the candidate target cells in a non-NES mode to the first NES CHO threshold offset; and comparing the measurements of the reference signals from a second subset of the candidate target cells in an NES mode to the second NES CHO threshold offset. In certain such embodiments, at least one of the CHO configuration and the NES CHO configuration further comprises, for each of the candidate target cells, an indication of operating in the NES mode. In other embodiments, at least one of the CHO configuration and the NES CHO configuration further comprises, for each of the candidate target cells or for a group of the candidate target cells, a priority value used when selecting the target cell from among the candidate target cells. The priority value may be based on a respective NES technique used by each of the candidate target cells or the group of candidate target cells. In other embodiments, at least one of the first NES CHO threshold offset and the second NES CHO threshold offset comprises an RSRP offset or an RSRQ offset configured for the CHO event.

In some embodiments of the method 300, the NES CHO configuration comprises an NES CHO condition. Evaluating the CHO condition comprises analyzing measurements of the reference signals from the candidate target cells to detect a CHO event. Performing the NES CHO evaluation comprises analyzing the measurements of the reference signals from one or more of the candidate target cells to detect an NES CHO event based on the NES CHO condition. In certain such embodiments, the NES CHO condition is satisfied when an RSRP or an RSRQ of the target cell reaches a threshold value.

In some embodiments, the method 300 further includes, in response to detecting that the source cell is in the NES mode, switching from a first S-measure configuration to a second S-measure configuration defining when the UE is to perform measurements on the candidate target cells based on a quality of the source cell.

In some embodiments of the method 300, evaluating the CHO condition based on the CHO configuration comprises using different CHO evaluation thresholds for two or more of the candidate target cells.

In some embodiments of the method 300, evaluating the CHO condition based on the CHO configuration comprises, in response to determining that more than one of the candidate target cells satisfies the CHO condition, prioritizing a first subset of the candidate target cells in a non-NES mode over a second subset of the candidate target cells in the NES mode. Certain such embodiments further include following an order defined in a configured cell list in the CHO configuration to prioritize the first subset of the candidate target cells in the non-NES mode without detecting the second subset of the candidate target cells in the NES mode.

In some embodiments of the method 300, evaluating the CHO condition based on the CHO configuration comprises, in response to determining that more than one of the candidate target cells satisfies the CHO condition, selecting one of the candidate target cells that satisfies the CHO condition with a highest configured priority value to execute the handover.

In some embodiments of the method 300, detecting that the source cell is in the NES mode comprises one or more of: detecting that the source cell starts to bar legacy UEs via monitoring at least one of MIB and a SIB of the source cell; receiving RRC or L1/L2 signaling, from the source cell, to apply cell DTX/DRX; receiving the RRC or L1/L2 signaling, from the source cell, to apply spatial elements adaptation; receiving the RRC or L1/L2 signaling, from the source cell, to apply PDSCH transmit power adaptation; and receiving a UE group common L1/L2 signaling or a UE dedicated L1/L2 signaling, from the source cell, triggering handover execution. In certain such embodiments, detecting that the source cell starts to bar the legacy UEs via monitoring at least one of the MIB and the SIB of the source cell comprises: determining that a cellBarred bit in the MIB is set to true and an allowNESUE bit in a SIB1 is set to true; or determining that a cell reservation bit in the SIB1 is set to true and the allowNESUE bit in the SIB1 is set to true. In certain embodiments, in response to receiving the UE group common L1/L2 signaling or the UE dedicated L1/L2 signaling triggering the handover execution, the method 300 further comprises responding to the source cell with L2 signaling for confirmation.

In some embodiments, the method 300 further includes, in response to determining that a handover execution fails, performing a cell selection procedure wherein, if both a first subset of the candidate target cells in a non-NES mode and a second subset of the candidate target cells in the NES mode configured in the CHO configuration are suitable candidates, prioritizing the first subset over the second subset during the cell selection procedure.

In some embodiments, the method 300 further includes, in response to determining that a handover execution fails, performing a cell selection procedure wherein, if any of the candidate target cells configured in the CHO configuration are suitable candidates, following configured priority values during the cell selection procedure.

Embodiments contemplated herein include an apparatus comprising means to perform one or more elements of the method 300. This apparatus may be, for example, an apparatus of a UE (such as a wireless device 602 that is a UE, as described herein).

Embodiments contemplated herein include one or more non-transitory computer-readable media comprising instructions to cause an electronic device, upon execution of the instructions by one or more processors of the electronic device, to perform one or more elements of the method 300. This non-transitory computer-readable media may be, for example, a memory of a UE (such as a memory 606 of a wireless device 602 that is a UE, as described herein).

Embodiments contemplated herein include an apparatus comprising logic, modules, or circuitry to perform one or more elements of the method 300. This apparatus may be, for example, an apparatus of a UE (such as a wireless device 602 that is a UE, as described herein).

Embodiments contemplated herein include an apparatus comprising: one or more processors and one or more computer-readable media comprising instructions that, when executed by the one or more processors, cause the one or more processors to perform one or more elements of the method 300. This apparatus may be, for example, an apparatus of a UE (such as a wireless device 602 that is a UE, as described herein).

Embodiments contemplated herein include a signal as described in or related to one or more elements of the method 300.

Embodiments contemplated herein include a computer program or computer program product comprising instructions, wherein execution of the program by a processor is to cause the processor to carry out one or more elements of the method 300. The processor may be a processor of a UE (such as a processor(s) 604 of a wireless device 602 that is a UE, as described herein). These instructions may be, for example, located in the processor and/or on a memory of the UE (such as a memory 606 of a wireless device 602 that is a UE, as described herein).

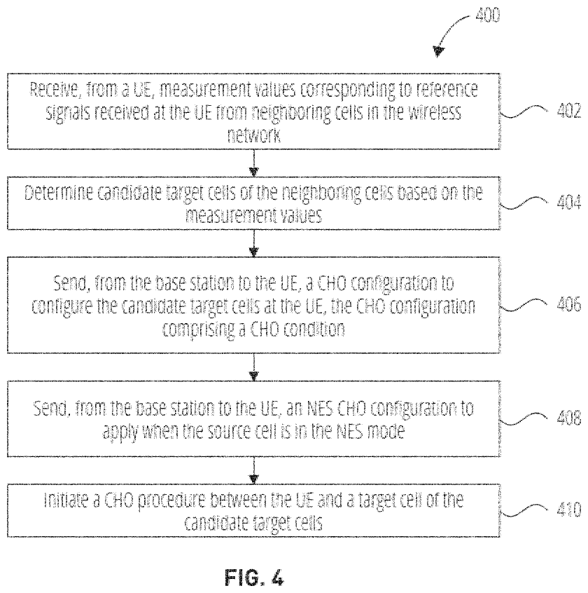

FIG. 4 illustrates a flowchart of a method 400 of a base station configured as a source cell for CHO in a wireless network including cells in an NES mode, according to one embodiment. The method 400 includes receiving 402, from a UE, measurement values corresponding to reference signals received at the UE from neighboring cells in the wireless network. The method 400 further includes determining 404 candidate target cells of the neighboring cells based on the measurement values. The method 400 further includes sending 406, from the base station to the UE, a CHO configuration to configure the candidate target cells at the UE, the CHO configuration comprising a CHO condition. The method 400 further includes sending 408, from the base station to the UE, an NES CHO configuration to apply when the source cell is in the NES mode. The method 400 further includes initiating 410 a CHO procedure between the UE and a target cell of the candidate target cells.

In some embodiments of the method 400, at least one of the CHO configuration and the NES CHO configuration further comprises, for each of the candidate target cells, an indication of operating in the NES mode.

In some embodiments of the method 400, at least one of the CHO configuration and the NES CHO configuration further comprises, for each of the candidate target cells or for a group of the candidate target cells, a priority value for selecting the target cell from among the candidate target cells. In certain such embodiments, the priority value is based on a respective NES technique used by each of the candidate target cells or the group of candidate target cells.

In some embodiments of the method 400, the NES CHO configuration comprises a first NES CHO threshold offset for an NES CHO evaluation. In certain such embodiments, the NES CHO configuration further comprises a second NES CHO threshold offset, and the NES CHO evaluation is based on: a first comparison of measurements of the reference signals from a first subset of the candidate target cells in a non-NES mode to the first NES CHO threshold offset; and a second comparison of the measurements of the reference signals from a second subset of the candidate target cells in an NES mode to the second NES CHO threshold offset. In certain such embodiments, at least one of the first NES CHO threshold offset and the second NES CHO threshold offset comprises an RSRP offset or an RSRQ offset configured for a CHO event.

In some embodiments of the method 400, the NES CHO configuration comprises an NES CHO condition, a CHO event is based on the CHO condition, and an NES CHO event is based on the NES CHO condition. In certain such embodiments, the NES CHO condition is satisfied when an RSRP or an RSRQ of the target cell reaches a threshold value.

In some embodiments of the method 400, at least one of the CHO configuration and the NES CHO configuration comprises an indication of whether the source cell is in the NES mode.

In some embodiments of the method 400, in response to the source cell entering the NES mode, the source cell performs one or more of: starting to bar legacy UEs via at least one of MIB and a SIB of the source cell; transmitting, from the source cell to the UE, RRC or L1/L2 signaling to trigger cell DTX/DRX; transmitting, from the source cell to the UE, the RRC or L1/L2 signaling to trigger spatial elements adaptation, transmitting, from the source cell to the UE, the RRC or L1/L2 signaling to trigger PDSCH transmit power adaptation; and transmitting, from the source cell to the UE, a UE group common L1/L2 signaling or a UE dedicated L1/L2 signaling to trigger handover execution. In certain such embodiments, starting to bar the legacy UEs comprises: transmitting a cellBarred bit in the MIB that is set to true and an allowNESUE bit in a SIB1 that is set to true; or transmitting a cell reservation bit in the SIB1 that is set to true and the allowNESUE bit in the SIB1 that is set to true. In certain embodiments, in response to transmitting the UE group common L1/L2 signaling or the UE dedicated L1/L2 signaling triggering the handover execution, the method 400 further includes receiving L2 signaling from the UE for confirmation.

Certain embodiments of the method 400 further include receiving, at the source cell from the candidate target cells, inter-node signaling indicating whether or not the candidate target cells are, respectively, in the NES mode. In certain such embodiments, the inter-node signaling indicates that the candidate target cells apply at least one of a cell DTX and a DRX. In addition or in other embodiments, the inter-node signaling indicates that the candidate target cells apply a spatial element adaptation, a PDSCH transmit power adaptation, and/or a paging enhancement.

In some embodiments, the method 400 further includes receiving, at the source cell from the candidate target cells, inter-node signaling indicating one or more preferred priority values suggested, respectively, by the candidate target cells. Certain such embodiments further comprise including configured priority values in the NES CHO configuration based on the one or more preferred priority values suggested by the candidate target cells.

Embodiments contemplated herein include an apparatus comprising means to perform one or more elements of the method 400. This apparatus may be, for example, an apparatus of a base station (such as a network device 618 that is a base station, as described herein).

Embodiments contemplated herein include one or more non-transitory computer-readable media comprising instructions to cause an electronic device, upon execution of the instructions by one or more processors of the electronic device, to perform one or more elements of the method 400. This non-transitory computer-readable media may be, for example, a memory of a base station (such as a memory 622 of a network device 618 that is a base station, as described herein).

Embodiments contemplated herein include an apparatus comprising logic, modules, or circuitry to perform one or more elements of the method 400. This apparatus may be, for example, an apparatus of a base station (such as a network device 618 that is a base station, as described herein).

Embodiments contemplated herein include an apparatus comprising: one or more processors and one or more computer-readable media comprising instructions that, when executed by the one or more processors, cause the one or more processors to perform one or more elements of the method 400. This apparatus may be, for example, an apparatus of a base station (such as a network device 618 that is a base station, as described herein).

Embodiments contemplated herein include a signal as described in or related to one or more elements of the method 400.

Embodiments contemplated herein include a computer program or computer program product comprising instructions, wherein execution of the program by a processing element is to cause the processing element to carry out one or more elements of the method 400. The processor may be a processor of a base station (such as a processor(s) 620 of a network device 618 that is a base station, as described herein). These instructions may be, for example, located in the processor and/or on a memory of the base station (such as a memory 622 of a network device 618 that is a base station, as described herein).

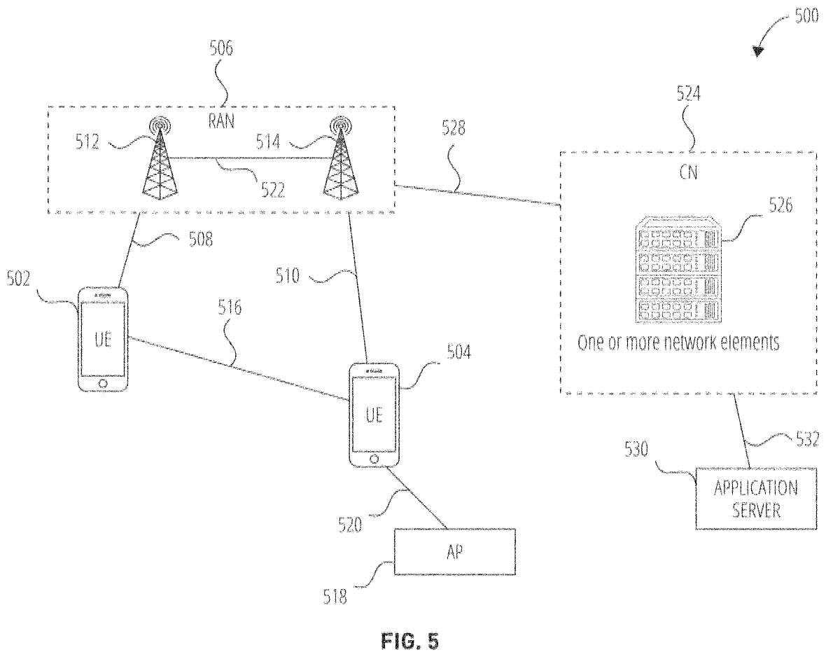

FIG. 5 illustrates an example architecture of a wireless communication system 500, according to embodiments disclosed herein. The following description is provided for an example wireless communication system 500 that operates in conjunction with the LTE system standards and/or 5G or NR system standards as provided by 3GPP technical specifications.

As shown by FIG. 5, the wireless communication system 500 includes UE 502 and UE 504 (although any number of UEs may be used). In this example, the UE 502 and the UE 504 are illustrated as smartphones (e.g., handheld touchscreen mobile computing devices connectable to one or more cellular networks), but may also comprise any mobile or non-mobile computing device configured for wireless communication.

The UE 502 and UE 504 may be configured to communicatively couple with a RAN 506. In embodiments, the RAN 506 may be NG-RAN, E-UTRAN, etc. The UE 502 and UE 504 utilize connections (or channels) (shown as connection 508 and connection 510, respectively) with the RAN 506, each of which comprises a physical communications interface. The RAN 506 can include one or more base stations (such as base station 512 and base station 514) that enable the connection 508 and connection 510.

In this example, the connection 508 and connection 510 are air interfaces to enable such communicative coupling, and may be consistent with RAT(s) used by the RAN 506, such as, for example, an LTE and/or NR.

In some embodiments, the UE 502 and UE 504 may also directly exchange communication data via a sidelink interface 516. The UE 504 is shown to be configured to access an access point (shown as AP 518) via connection 520. By way of example, the connection 520 can comprise a local wireless connection, such as a connection consistent with any IEEE 802.11 protocol, wherein the AP 518 may comprise a Wi-Fi® router. In this example, the AP 518 may be connected to another network (for example, the Internet) without going through a CN 524.

In embodiments, the UE 502 and UE 504 can be configured to communicate using orthogonal frequency division multiplexing (OFDM) communication signals with each other or with the base station 512 and/or the base station 514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 512 or base station 514 may be implemented as one or more software entities running on server computers as part of a virtual network. In addition, or in other embodiments, the base station 512 or base station 514 may be configured to communicate with one another via interface 522. In embodiments where the wireless communication system 500 is an LTE system (e.g., when the CN 524 is an EPC), the interface 522 may be an X2 interface. The X2 interface may be defined between two or more base stations (e.g., two or more eNBs and the like) that connect to an EPC, and/or between two eNBs connecting to the EPC. In embodiments where the wireless communication system 500 is an NR system (e.g., when CN 524 is a 5GC), the interface 522 may be an Xn interface. The Xn interface is defined between two or more base stations (e.g., two or more gNBs and the like) that connect to 5GC, between a base station 512 (e.g., a gNB) connecting to 5GC and an eNB, and/or between two eNBs connecting to 5GC (e.g., CN 524).

The RAN 506 is shown to be communicatively coupled to the CN 524. The CN 524 may comprise one or more network elements 526, which are configured to offer various data and telecommunications services to customers/subscribers (e.g., users of UE 502 and UE 504) who are connected to the CN 524 via the RAN 506. The components of the CN 524 may be implemented in one physical device or separate physical devices including components to read and execute instructions from a machine-readable or computer-readable medium (e.g., a non-transitory machine-readable storage medium).

In embodiments, the CN 524 may be an EPC, and the RAN 506 may be connected with the CN 524 via an S1 interface 528. In embodiments, the S1 interface 528 may be split into two parts, an S1 user plane (S1-U) interface, which carries traffic data between the base station 512 or base station 514 and a serving gateway (S-GW), and the S1-MME interface, which is a signaling interface between the base station 512 or base station 514 and mobility management entities (MMEs).

In embodiments, the CN 524 may be a 5GC, and the RAN 506 may be connected with the CN 524 via an NG interface 528. In embodiments, the NG interface 528 may be split into two parts, an NG user plane (NG-U) interface, which carries traffic data between the base station 512 or base station 514 and a user plane function (UPF), and the S1 control plane (NG-C) interface, which is a signaling interface between the base station 512 or base station 514 and access and mobility management functions (AMFs).

Generally, an application server 530 may be an element offering applications that use internet protocol (IP) bearer resources with the CN 524 (e.g., packet switched data services). The application server 530 can also be configured to support one or more communication services (e.g., VoIP sessions, group communication sessions, etc.) for the UE 502 and UE 504 via the CN 524. The application server 530 may communicate with the CN 524 through an IP communications interface 532.

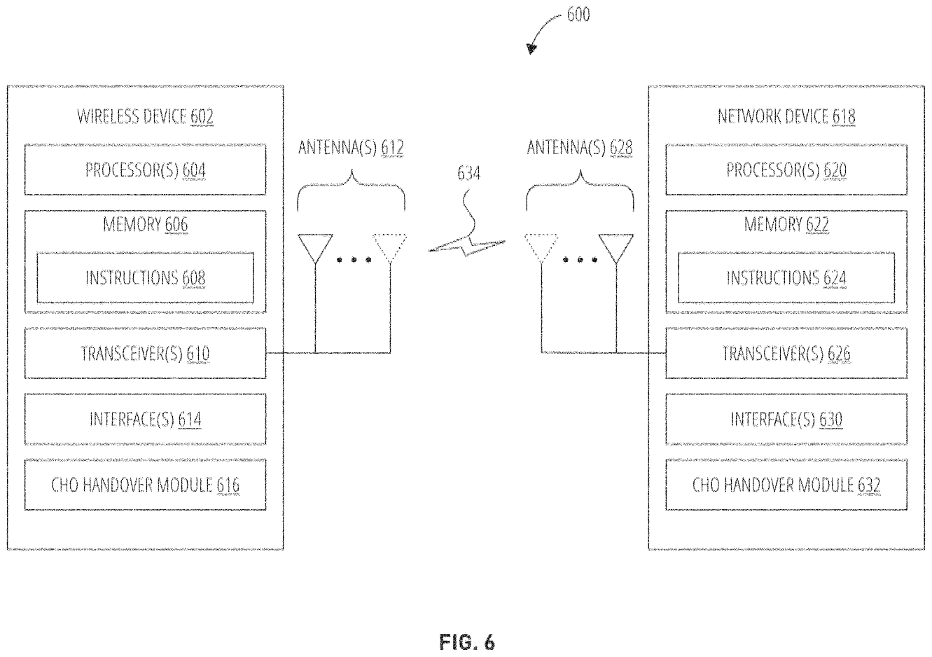

FIG. 6 illustrates a system 600 for performing signaling 634 between a wireless device 602 and a network device 618, according to embodiments disclosed herein. The system 600 may be a portion of a wireless communications system as herein described. The wireless device 602 may be, for example, a UE of a wireless communication system. The network device 618 may be, for example, a base station (e.g., an eNB or a gNB) of a wireless communication system.

The wireless device 602 may include one or more processor(s) 604. The processor(s) 604 may execute instructions such that various operations of the wireless device 602 are performed, as described herein. The processor(s) 604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 602 may include a memory 606. The memory 606 may be a non-transitory computer-readable storage medium that stores instructions 608 (which may include, for example, the instructions being executed by the processor(s) 604). The instructions 608 may also be referred to as program code or a computer program. The memory 606 may also store data used by, and results computed by, the processor(s) 604.

The wireless device 602 may include one or more transceiver(s) 610 that may include radio frequency (RF) transmitter and/or receiver circuitry that use the antenna(s) 612 of the wireless device 602 to facilitate signaling (e.g., the signaling 634) to and/or from the wireless device 602 with other devices (e.g., the network device 618) according to corresponding RATs.

The wireless device 602 may include one or more antenna(s) 612 (e.g., one, two, four, or more). For embodiments with multiple antenna(s) 612, the wireless device 602 may leverage the spatial diversity of such multiple antenna(s) 612 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 602 may be accomplished according to precoding (or digital beamforming) that is applied at the wireless device 602 that multiplexes the data streams across the antenna(s) 612 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 602 may implement analog beamforming techniques, whereby phases of the signals sent by the antenna(s) 612 are relatively adjusted such that the (joint) transmission of the antenna(s) 612 can be directed (this is sometimes referred to as beam steering).

The wireless device 602 may include one or more interface(s) 614. The interface(s) 614 may be used to provide input to or output from the wireless device 602. For example, a wireless device 602 that is a UE may include interface(s) 614 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 610/antenna(s) 612 already described) that allow for communication between the UE and other devices and may operate according to known protocols (e.g., Wi-Fi®, Bluetooth®, and the like).

The wireless device 602 may include a CHO Handover module 616. The CHO Handover module 616 may be implemented via hardware, software, or combinations thereof. For example, the CHO Handover module 616 may be implemented as a processor, circuit, and/or instructions 608 stored in the memory 606 and executed by the processor(s) 604. In some examples, the CHO Handover module 616 may be integrated within the processor(s) 604 and/or the transceiver(s) 610. For example, the CHO Handover module 616 may be implemented by a combination of software components (e.g., executed by a DSP or a general processor) and hardware components (e.g., logic gates and circuitry) within the processor(s) 604 or the transceiver(s) 610.

The CHO Handover module 616 may be used for various aspects of the present disclosure, for example, aspects of FIG. 1A, FIG. 1B, FIG. 2, and FIG. 3.

The network device 618 may include one or more processor(s) 620. The processor(s) 620 may execute instructions such that various operations of the network device 618 are performed, as described herein. The processor(s) 620 may include one or more baseband processors implemented using, for example, a CPU, a DSP, an ASIC, a controller, an FPGA device, another hardware device, a firmware device, or any combination thereof configured to perform the operations described herein.

The network device 618 may include a memory 622. The memory 622 may be a non-transitory computer-readable storage medium that stores instructions 624 (which may include, for example, the instructions being executed by the processor(s) 620). The instructions 624 may also be referred to as program code or a computer program. The memory 622 may also store data used by, and results computed by, the processor(s) 620.

The network device 618 may include one or more transceiver(s) 626 that may include RF transmitter and/or receiver circuitry that use the antenna(s) 628 of the network device 618 to facilitate signaling (e.g., the signaling 634) to and/or from the network device 618 with other devices (e.g., the wireless device 602) according to corresponding RATs.

The network device 618 may include one or more antenna(s) 628 (e.g., one, two, four, or more). In embodiments having multiple antenna(s) 628, the network device 618 may perform MIMO, digital beamforming, analog beamforming, beam steering, etc., as has been described.

The network device 618 may include one or more interface(s) 630. The interface(s) 630 may be used to provide input to or output from the network device 618. For example, a network device 618 that is a base station may include interface(s) 630 made up of transmitters, receivers, and other circuitry (e.g., other than the transceiver(s) 626/antenna(s) 628 already described) that enables the base station to communicate with other equipment in a core network, and/or that enables the base station to communicate with external networks, computers, databases, and the like for purposes of operations, administration, and maintenance of the base station or other equipment operably connected thereto.

The network device 618 may include a CHO Handover module 632. The CHO Handover module 632 may be implemented via hardware, software, or combinations thereof. For example, the CHO Handover module 632 may be implemented as a processor, circuit, and/or instructions 624 stored in the memory 622 and executed by the processor(s) 620. In some examples, the CHO Handover module 632 may be integrated within the processor(s) 620 and/or the transceiver(s) 626. For example, the CHO Handover module 632 may be implemented by a combination of software components (e.g., executed by a DSP or a general processor) and hardware components (e.g., logic gates and circuitry) within the processor(s) 620 or the transceiver(s) 626.

The CHO Handover module 632 may be used for various aspects of the present disclosure, for example, aspects of FIG. 1A, FIG. 1B, FIG. 2, and FIG. 4.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a base station configured as a source cell for conditional handover (CHO) in a wireless network including cells in a network energy saving (NES) mode, the method comprising:
receiving, from a user equipment (UE), measurement values corresponding to reference signals received at the UE from neighboring cells in the wireless network;
determining candidate target cells of the neighboring cells based on the measurement values;
sending, from the base station to the UE, a CHO configuration to configure the candidate target cells at the UE, the CHO configuration comprising a CHO condition;
sending, from the base station to the UE, an NES CHO configuration to apply when the source cell is in the NES mode; and
initiating a CHO procedure between the UE and a target cell of the candidate target cells.

2. The method of claim 1, wherein at least one of the CHO configuration and the NES CHO configuration further comprises, for each of the candidate target cells, an indication of operating in the NES mode.

3. The method of claim 1, wherein at least one of the CHO configuration and the NES CHO configuration further comprises, for each of the candidate target cells or for a group of the candidate target cells, a priority value for selecting the target cell from among the candidate target cells.

4. The method of claim 3, wherein the priority value is based on a respective NES technique used by each of the candidate target cells or the group of candidate target cells.

5. The method of claim 1, wherein the NES CHO configuration comprises a first NES CHO threshold offset for an NES CHO evaluation.

6. The method of claim 5, wherein the NES CHO configuration further comprises a second NES CHO threshold offset, and wherein the NES CHO evaluation is based on:
a first comparison of measurements of the reference signals from a first subset of the candidate target cells in a non-NES mode to the first NES CHO threshold offset; and
a second comparison of the measurements of the reference signals from a second subset of the candidate target cells in an NES mode to the second NES CHO threshold offset.

7. The method of claim 6, wherein at least one of the first NES CHO threshold offset and the second NES CHO threshold offset comprises a reference signal received power (RSRP) offset or a reference signal received quality (RSRQ) offset configured for a CHO event.

8. The method of claim 1, wherein the NES CHO configuration comprises an NES CHO condition;
wherein a CHO event is based on the CHO condition; and
wherein an NES CHO event is based on the NES CHO condition.

9. The method of claim 8, wherein the NES CHO condition is satisfied when a reference signal received power (RSRP) or a reference signal received quality (RSRQ) of the target cell reaches a threshold value.

10. The method of claim 1, wherein at least one of the CHO configuration and the NES CHO configuration comprises an indication of whether the source cell is in the NES mode.

11. The method of claim 1, wherein in response to the source cell entering the NES mode, the source cell performs one or more of:
starting to bar legacy UEs via at least one of Master Information Block (MIB) and a System Information Block (SIB) of the source cell;
transmitting, from the source cell to the UE, Radio Resource Control (RRC) or Layer 1/Layer 2 (L1/L2) signaling to trigger cell Discontinuous Transmission and Discontinuous Reception (DTX/DRX);
transmitting, from the source cell to the UE, the RRC or L1/L2 signaling to trigger spatial elements adaptation;
transmitting, from the source cell to the UE, the RRC or L1/L2 signaling to trigger Physical Downlink Shared Channel (PDSCH) transmit power adaptation; and
transmitting, from the source cell to the UE, a UE group common L1/L2 signaling or a UE dedicated L1/L2 signaling to trigger handover execution.

12. The method of claim 11, wherein starting to bar the legacy UEs comprises:
transmitting a cellBarred bit in the MIB that is set to true and an allowNESUE bit in a first SIB (SIB1) that is set to true; or
transmitting a cell reservation bit in the SIB1 that is set to true and the allowNESUE bit in the SIB1 that is set to true.

13. The method of claim 11, further comprising, in response to transmitting the UE group common L1/L2 signaling or the UE dedicated L1/L2 signaling triggering the handover execution, receiving L2 signaling from the UE for confirmation.

14. The method of claim 1, further comprising receiving, at the source cell from the candidate target cells, inter-node signaling indicating whether or not the candidate target cells are, respectively, in the NES mode.

15. The method of claim 14, wherein the inter-node signaling indicates that the candidate target cells apply at least one of a cell Discontinuous Transmission (DTX) and a Discontinuous Reception (DRX).

16. The method of claim 14, wherein the inter-node signaling indicates that the candidate target cells apply a spatial element adaptation.

17. The method of claim 14, wherein the inter-node signaling indicates that the candidate target cells apply a Physical Downlink Shared Channel (PDSCH) transmit power adaptation.

18. The method of claim 14, wherein the inter-node signaling indicates that the candidate target cells apply a paging enhancement.

19. The method of claim 1, further comprising receiving, at the source cell from the candidate target cells, inter-node signaling indicating one or more preferred priority values suggested, respectively, by the candidate target cells.

20. The method of claim 19, further comprising including configured priority values in the NES CHO configuration based on the one or more preferred priority values suggested by the candidate target cells.

21-23. (canceled)
